(19) United States
(12) Patent Application Publication
(10) Pub. No.: US 2012/0038279 A1
(43) Pub. Date: Feb. 16, 2012

(54) LIGHT ADJUSTABLE TABLE LAMP AND THE LIGHT AUTO ADJUST METHOD THEREOF

(75) Inventors: Shun-Yung Chang, Taipei City (TW); Jiaqing Zhuang, Zhangzhou (CN)

(73) Assignee: Tsann Kuen (Zhangzhou) Enterprise Co., Ltd., Fujian Province (CN)

(21) Appl. No.: 13/207,725

(22) Filed: Aug. 11, 2011

(30) Foreign Application Priority Data
Aug. 11, 2010 (CN) 201010251264.6

(51) Int. Cl. H05B 37/02

(52) U.S. Cl. 315/151

(57) ABSTRACT

The light adjustable table lamp includes a base, a stand pole, lighting equipment, optical sensor, a keyboard, a single-chip and a drive. The lower end of the stand pole is disposed in the rear of the base, and the upper end of the stand pole is equipped with a pendulum. The lighting equipment is disposed in the front of the pendulum. The optical sensors A and B are disposed on the top surface in front of the base. The three input ports of the single-chip joints to the keyboard, the optical sensors A and B separately. The single-chip controls the drive to supply energy to the lighting equipment according to the comparison of the real time light intensity of the user reading area and the light intensity setting value from the keyboard, maintaining the light intensity of the user reading area in the setting level.

### FIELD OF THE INVENTION

The present invention relates to a light adjustable table lamp and the light auto adjust method thereof.

### BACKGROUND OF THE INVENTION

The existing table lamp of light auto adjustable includes a base, a stand pole, lighting equipment, optical sensor, adjust device and a controller. The lower end of the stand pole is fixed to the base, and the upper end is configured to the lighting equipment. The adjust device and the controller are disposed to the base. The optical sensor is disposed somewhere near the user reading area. The light auto adjust method of the existing table lamp adjusts the status parameter of the lighting equipment directly for the user needs of the light intensity. The adjust device provides the status parameter to the controller, and the optical sensor provides light intensity signal of the measured position to the controller. The controller determines the energy to the lighting equipment automatically according to the status parameter and the light intensity signal of the measured position. And then the controller maintains the light intensity of the measured position in the given level. If the user changes the position of the lighting equipment, the relative position of the user reading area and the optical sensor changes. The controller can not determine the energy to the lighting equipment automatically to maintain the light intensity of the measured position in the given level. So the existing table lamp of light auto adjustable is not permitted to change the position. And the user reading area in the light of the lighting equipment is not adjustable, which is unequal to the needs to adjust the reading area in all direction.

### SUMMARY OF THE INVENTION

The present invention provides a light adjustable table lamp and the light auto adjust method thereof, the position of the lighting equipment is adjustable and the light intensity of the reading area is stabilized automatically.

The technical proposal of the present invention is: A light adjustable table lamp includes a base, a stand pole, a lighting equipment, optical sensor, adjust device and a controller; the adjust device provides state parameter to the controller; wherein the adjust device is a keyboard, the state parameter is the light intensity setting value of the user reading area; the controller includes single-chip and a drive; the lower end of the stand pole is disposed in the rear of the base, the upper end of the stand pole is disposed with a pendulum which can swing horizontally, the lighting equipment is disposed in the front of the pendulum; an optical sensor A and an optical sensor B are disposed on the top surface in the front of the base; the three input ports of the single-chip joints to the keyboard, the optical sensor A and the optical sensor B separately; the single-chip calculates automatically the real time light intensity of the user reading area according to the light intensity signals of the optical sensor A and the optical sensor B, then the single-chip controls the drive with the energy supplied to the lighting equipment according to the light intensity setting value of the user reading area by the keyboard, maintaining the light intensity of the user reading area in the given level.

Light auto adjust method for the light adjustable table lamp above, wherein the light adjustable table lamp includes a base, a stand pole, a lighting equipment, optical sensor, a keyboard, a single-chip and a drive; the lower end of the stand pole is disposed in the rear of the base, the upper end of the stand pole is disposed with a pendulum which can swing horizontally, the lighting equipment is disposed in the front of the pendulum; an optical sensor A and an optical sensor B are disposed on the top surface in the front of the base; the three input ports of the single-chip joints to the keyboard, the optical sensor A and the optical sensor B separately; the single-chip controls the drive to transport the energy to the lighting equipment; the steps of the light adjustable table lamp to adjust light are:

Step 1, measure the light intensity data of the optical sensor A and the optical sensor B when the pendulum is at the different deflection angle; make the ratio-angle sheet about the relative relationship of the ratio of the light intensity data of the optical sensor A to the optical sensor B and the deflection angel of the pendulum; make the angle-light intensity sheet about the relative relationship of the light intensity data of the optical sensor A and the optical sensor B when the pendulum is at different deflection angle and the light intensity of the user reading area; make sub sheet for every deflection angle of the pendulum in the angle-light intensity sheet; every sub sheet records the light intensity value of the user reading area for the different light intensity data of the optical sensor A and the optical sensor B at the corresponding deflection angle of the pendulum, then go to the step 2;

Step 2, if the keyboard receives signal, read and save the light intensity setting value S of the user reading area provided by the keyboard; then go to the step 3;

Step 3, read and save the light intensity sense data GA, GB of the optical sensor A and the optical sensor B, then go to the step 4;

Step 4, calculate the ratio X of the two light intensity sense data GA and GB, find out the pendulum deflection angle L corresponding to the ratio X in the ratio-angle sheet;

Step 5, find out the real time light intensity Q of the user reading area corresponding to the two light intensity sense data GA and GB in the angle-light intensity sheet, then go to the step 6;

Step 6, make a judgment about whether the light intensity Q is equal to the light intensity setting value S, if equal, it's no need to adjust the light, then go to the step 2; if unequal, adjust the light, then go to the step 7;

Step 7, calculate the new control data from the real time light intensity Q and the light intensity setting value S, then go to the step 8;

Step 8, the new control signal is output to the drive, maintain the light intensity of the user reading area in the setting level, then go the step 2.

Another technical proposal of the present invention is: a light adjustable table lamp includes a base, a stand pole, a lighting equipment, optical sensor, an adjust device and a controller; the adjust device provides the state parameter to the controller; wherein the adjust device is a keyboard, and the state parameter is the light intensity setting value of the user reading area; the controller includes a single-chip and a drive; the lower end of the stand pole is disposed in the rear of the base, the upper end of the stand pole is disposed with a pendulum which can swing horizontally; the lighting equipment is disposed in the front of the pendulum; an optical sensor A, an optical sensor B and an optical sensor C are disposed on the top surface of the front of the base; the four input ports of the single-chip joints to the keyboard, the optical sensor A, the optical sensor B and the optical sensor C separately; the single-chip calculates the real time light intensity of the user reading area automatically according to any two of the optical sensors of the optical sensor A, the optical sensor B and the optical sensor C; then the single-chip controls the drive to supply energy to the lighting equipment according to the light intensity setting value of the user reading area by the keyboard, maintaining the light intensity of the user reading area in the given level.

Light auto adjust method for the light adjustable table lamp above, the light adjustable table lamp includes a base, a stand pole, a lighting equipment, optical sensor, a keyboard, a single-chip and a drive; the lower end of the stand pole is disposed in the rear of the base, the upper end of the stand pole is disposed with a pendulum which can swing horizontally; the lighting equipment is disposed in the front of the pendulum; an optical sensor A, an optical sensor B and an optical sensor C are disposed on the top surface of the front of the base; the four input ports of the single-chip joints to the keyboard, the optical sensor A, the optical sensor B and the optical sensor C separately; the single-chip controls the drive to supply energy to the lighting equipment; the steps of the light adjustable table lamp to adjust light are:

Step 1′, measure the light intensity data of the optical sensor A, the optical sensor B and the optical sensor C when the pendulum is at different deflection angle; make the ratio-angle sheet AB about the ratio of the light intensity data of the optical sensor A to the optical sensor B and the pendulum deflection angle; make the ratio-angel sheet AC about the ratio of the light intensity data of the optical sensor A to the optical sensor C and the pendulum deflection angle; make the ratio-angel sheet BC about the ratio of the light intensity data of the optical sensor B to the optical sensor C and the pendulum deflection angle; make the angle-light intensity sheet AB about the relative relationship between the light intensity data of the optical sensor A and the optical sensor B when the pendulum is at different deflection angle and the light intensity of the user reading area; make the sub sheet about the every deflection angle of the pendulum in the angle-light intensity sheet AB, and every sub sheet records the light intensity of the user reading area corresponding to the different light intensity data of the optical sensor A and the optical sensor B in this pendulum deflection angle; make the angle-light intensity sheet AC about the relative relationship between the light intensity data of the optical sensor A and the optical sensor C when the pendulum is at different deflection angle and the light intensity of the user reading area; make the sub sheet about the every deflection angle of the pendulum in the angle-light intensity sheet AC, and every sub sheet records the light intensity of the user reading area corresponding to the different light intensity data of the optical sensor A and the optical sensor C in this pendulum deflection angle; make the angle-light intensity sheet BC about the relative relationship between the light intensity data of the optical sensor B and the optical sensor C when the pendulum is at different deflection angle and the light intensity of the user reading area; make the sub sheet about the every deflection angle of the pendulum in the angle-light intensity sheet BC, and every sub sheet records the light intensity of the user reading area corresponding to the different light intensity data of the optical sensor B and the optical sensor C in this pendulum deflection angle; then go to the step 2′;

Step 2′, if the keyboard receives signal, read and save the light intensity setting value S of the user reading area from the keyboard, then go to the step 3′;

Step 3′, read and save the light intensity sense data GA, GB and GC from the optical sensor A, optical sensor B and the optical sensor C; then go to the step 31′;

Step 31′, judge that whether the light intensity sense data GA, GB and GC from the optical sensor A, optical sensor B and the optical C are available data; if the light intensity sense data GA and GB from the optical sensor A and the optical sensor B are available, the optical sensor A and the optical sensor B are not be shielded, then go to the step 41′; if the light intensity sense data GA and GC from the optical sensor A and the optical sensor C are available, the optical sensor B is shielded, then go to the step 42′; if the light intensity sense data GB and GC are available, the optical sensor A is shielded, then go to the step 43′; if only one of the three light intensity sense data GA, GB and GC is available, there are two optical sensors are shielded and the table lamp is disadjustable, then go to the step 2′;

Step 41′, calculate the ratio X of the two light intensity sense data GA and GB, and find out the pendulum deflection angle L corresponding to the ratio X in the ratio-angle sheet AB; then go to the step 51′;

Step 51′, Find out the real time light intensity value Q of the user reading area corresponding to the two light intensity sense data GA and GB in the angle-light intensity sheet AB; then go to the step 6′;

Step 42′, calculate the ratio Y of the two light intensity sense data GA and GC, and find out the pendulum deflection angle M corresponding to the ratio Y in the ratio-angel sheet AC; then go to the step 52′;

Step 52′, find out the real time light intensity value Q of the user reading area corresponding to the two light intensity sense data GA and GC in the angle M sub sheet of the angle-light intensity AC; then go to the step 6′;

Step 43′, calculate the ratio Z of the two light intensity sense data GB and GC, find out the pendulum deflection angle N corresponding to the ratio Z in the ratio-angle sheet BC; then go to the step 53′;

Step 53′, find out the real time light intensity value Q of the user reading area corresponding to the two light intensity sense data GB and GC in the angle N sub sheet of the angle-light intensity BC; then go to the step 6′;

Step 6′, judge whether the real time light intensity value Q is equal to the light intensity setting value S; if equal, no need to adjust the light, then go to the step 2′; if unequal, adjust the light, then go to the step 7′;

Step 7′, calculate the new control data from the real time light intensity value Q and the light intensity setting value S, then go to the step 8′;

Step 8′, the new control signal is output to the drive, maintain the light intensity of the user reading area in the setting level; then go to the step 2′.

The light adjustable table lamp of the present invention changes the user reading area by adjusting the position of the lighting equipment, and the position of the lighting equipment is determined by the pendulum disposed in the upper end of the stand pole. The pendulum can swing horizontally. The table lamp is equipped with two optical sensors. The single-chip controls the drive to supply energy to the lighting equipment according to the comparison of the real time light intensity of the user reading area and the light intensity setting value from the keyboard, maintaining the light intensity of the user reading area in the setting level. The present invention solves the problem of the light auto adjust problem after the position of the lighting equipment is changed. The user can adjust the reading area and set the light intensity for the needs, which has a wide prospect in future market. Especially the three optical sensors disposed in the table lamp can calculate the real time light intensity of the user reading area and control the drive to supply energy to the lighting equipment by the user reading area light intensity setting value from the keyboard, maintaining the user reading area light intensity in the setting level. The present invention solves the problem that the light is disadjustable automatically when one of the optical sensors is shielded, making the reading undisturbed and satisfying the needs of the humanity.

The present invention of the light auto adjust method for a light adjustable table lamp determines the pendulum deflection angle and the real time light intensity of user reading area by the cooperation of the ratio-angle sheet and the angle-light intensity sheet measured previously with the real time light intensity data of the two optical sensors. The single-chip controls the drive to supply energy to the lighting equipment according to the comparison of the real time light intensity of the user reading area and the light intensity setting value from the keyboard, maintaining the light intensity of the user reading area in the setting level. The method solve the problem of the light adjust when the position of the lighting equipment is changed. The method is simple and applicable. Especially to the three optical sensors in the table lamp, the ratio-angle sheet and the angle-light intensity of two of the optical sensors are measured separately. When in operation, with the cooperation of the real time light intensity data of the two optical sensors unshielded and the corresponding ratio-angle sheet and the angle-light intensity sheet, the pendulum deflection angle and the real time light intensity of the user reading area is determined. The single-chip controls the drive to supply energy to the lighting equipment according to the comparison of the real time light intensity of the user reading area and the light intensity setting value from the keyboard, maintaining the light intensity of the user reading area in the setting level. The method is convenience for the users.

### BRIEF DESCRIPTION OF THE DRAWINGS

FIG. 1 illustrates the usage status of the table lamp in the first embodiment of the present invention;

FIG. 2 illustrates the diagram of the circuit in the first embodiment in the FIG. 1;

FIG. 3 illustrates the diagram of the real time light intensity signal and the ratio in the first embodiment;

FIG. 4 illustrates the main control flow chart in the first embodiment;

FIG. 5 illustrates the light adjust function subprogram in the main control flow chart in the FIG. 4;

FIG. 6 illustrates the usage status of the table lamp in the second embodiment of the present invention;

FIG. 7 illustrates the diagram of the circuit in the second embodiment;

FIG. 8 illustrates the diagram of the real time light intensity signal and the ratio in the second embodiment;

FIG. 9 illustrates the main control flow chart in the second embodiment;

FIG. 10 illustrates the light adjust function subprogram in the main control flow chart in the FIG. 9.

### DETAIL DESCRIPTION OF THE PREFERRED EMBODIMENT

### 1. The First Embodiment

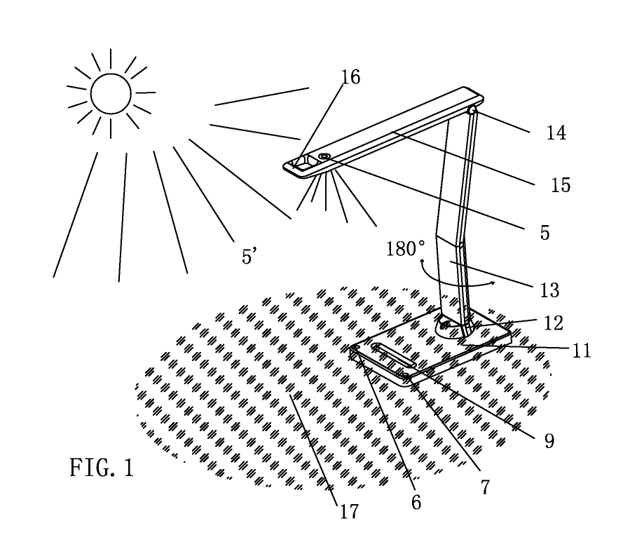

Refer to the FIG. 1, the usage status of the table lamp of light auto adjustable in the present invention. The mechanism of the light auto adjust table lamp includes a base 11, a rotating seat 12, a stand pole 13, a damping axis 14 and a pendulum 15. The rotating seat 12 is disposed on the top surface of the rear of the base 11. The rotating seat 12 rotates about the base 11 left or right in 90°. The lower end of the stand pole 13 is fixed to the rotating seat 12. The upper end of the stand pole 13 joints to the pendulum 15 of swinging horizontally by the damping axis 14. The front of the pendulum 15 is disposed with handle 16, and the rear of the handle 16 is disposed with LED 5 (lighting equipment). An optical sensor A 6 is disposed in the left on the top surface of the front edge of the base 11, while an optical sensor B 7 is disposed in the right. A keyboard 9 is disposed in the middle on the top surface of the base 11. The user reading area 17 is formed under the glare of the environment light 5′ and the LED light 5.

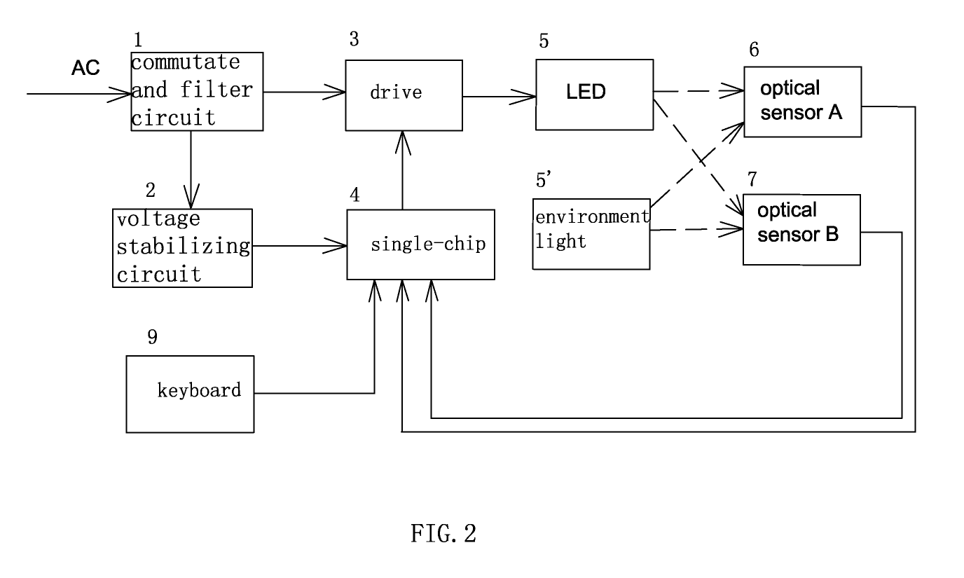

Refer to the FIG. 2, the electronic structure of the table lamp of light auto adjustable includes a commutate and filter circuit 1, a voltage stabilizing circuit 2, a drive 3, a single-chip 4, the LED 5, the optical sensor A 6, the optical sensor B 7 and the keyboard 9.

The commutate and filter circuit 1 transforms the AC mains to low-voltage DC provided to the voltage stabilizing circuit 2 and the drive 3 separately. The voltage stabilizing circuit 2 supplies with the working voltage for the single-chip 4. The drive 3 receives the PWM signal from the single-chip 4 and supplies energy to the LED 5. The three input ports of the single-chip joints to the keyboard 9, the optical sensor A 6 and the optical sensor B 7 separately. The single-chip 4 controls the drive 3 to supply energy to the LED 5 according to the comparison of the real time light intensity of the user reading area 17 and the light intensity setting value from the keyboard 9, maintaining the light intensity of the user reading area 17 in the setting level. The optical sensor A 6 and the optical sensor B 7 are photoresistors. The single-chip 4 takes AD sample for the voltage of these photoresistors.

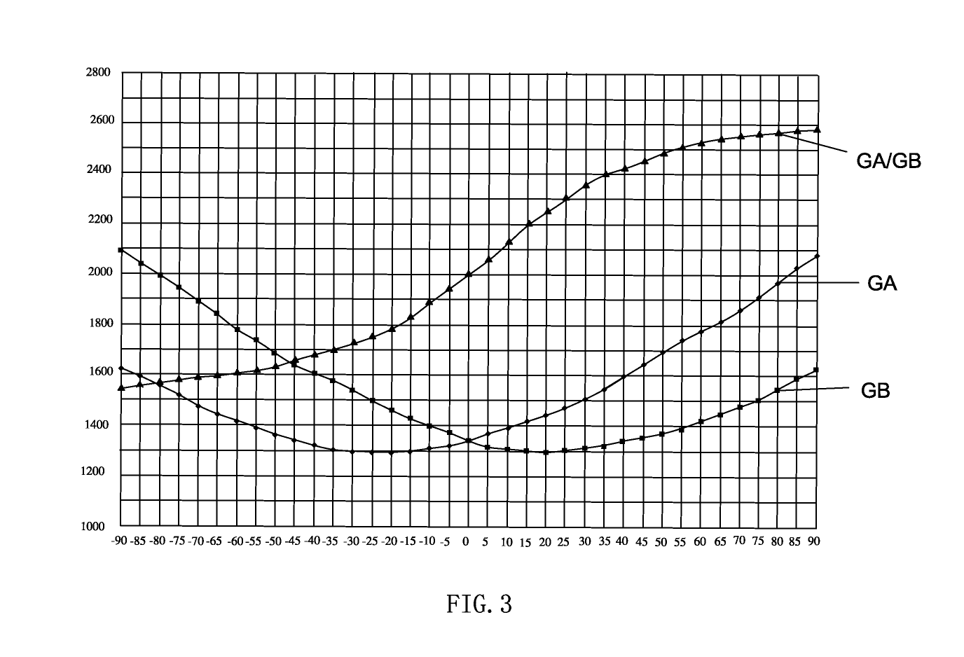

The light auto adjust method for the light adjustable table lamp measures the light intensity data of the optical sensor A 6 and the optical sensor B 7 when the pendulum 15 is at the different deflection angle; make the ratio-angle sheet about the relative relationship of the ratio of the light intensity data of the optical sensor A 6 to the optical sensor B 7 and the deflection angel of the pendulum 15, refer to the FIG. 3; and then make the angle-light intensity sheet about the relative relationship of the light intensity data of the optical sensor A 6 and the optical sensor B 7 when the pendulum 15 is at different deflection angle and the light intensity of the user reading area 17; make sub sheet for every deflection angle of the pendulum 15 in the angle-light intensity sheet; every sub sheet records the light intensity value of the user reading area 17 for the different light intensity data of the optical sensor A 6 and the optical sensor B 7 at the corresponding deflection angle of the pendulum 15.

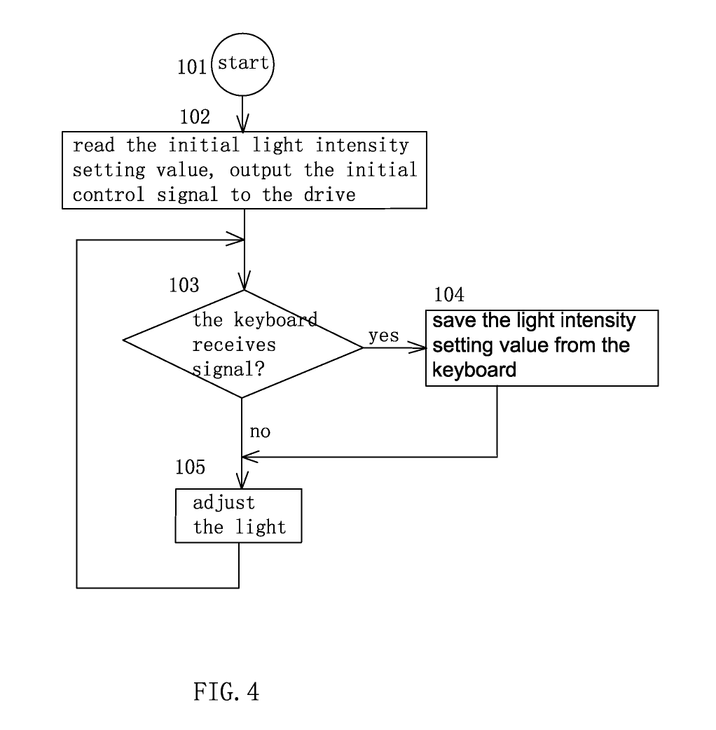

Refer to the FIG. 4 about the main control flow chart of the first embodiment.

Step 101, the main control flow chart is started when the single-chip 4 is powered; then go to the step 102.

Step 102, the single-chip 4 read the first light intensity setting value S from the internal memory and output the initial PWM signal to the drive 3, then go to the step 103.

Step 103, check that whether the keyboard 9 receives input signal, if does, then go to the step 104; if does not, then go to the step 105.

Step 104, read and save the light intensity setting value S of the user reading area 17 from the keyboard 9, then go to the step 105.

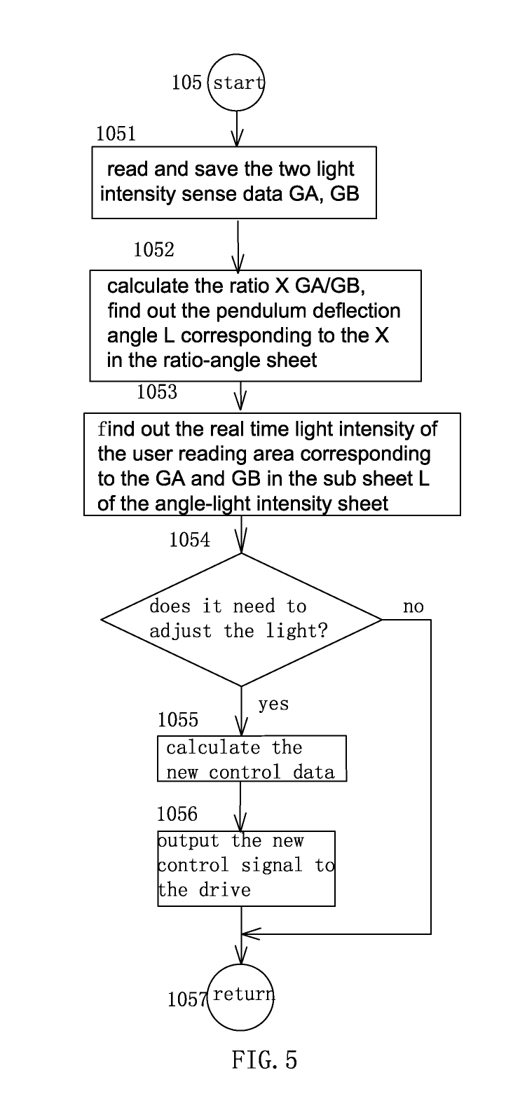

Step 105, adjust the light, and then go to the step 103. Refer to the FIG. 5 about the light adjust function subprogram in the step 105.

Sub step 1051, read and save the light intensity sense data GA, GB of the optical sensor A 6 and the optical sensor B 7; read several times (such as 16 times) of the light intensity data of the optical sensor A 6 when reading the light intensity sense data GA, GB of the optical sensor A 6 and the optical sensor B 7, and take the average value as the light intensity data GA, the same as the light intensity data GB. Then start the digital filter and go to the sub step 1052.

Sub step 1052, calculate the ratio X (GA/GB) of the two light intensity sense data GA and GB, find out the pendulum deflection angle L corresponding to the ratio X in the ratio-angle sheet; then go to the sub step 1053.

Sub step 1053, find out the real time light intensity Q of the user reading area corresponding to the two light intensity sense data GA and GB in the angle-light intensity sheet, then go to the sub step 1054.

Sub step 1054, make a judgment about whether the light intensity Q is equal to the light intensity setting value S, if equal, it's no need to adjust the light, then go to the step 2; if unequal, adjust the light, then go to the step 1055. Step 1055, calculate the new control data from the real time light intensity Q and the light intensity setting value S. Firstly calculate the feedback compensation value in the equation W=S−aQ, where the a is the proportionality. Correct the PWM signal pulse-width (the duty ratio) according to the feedback compensation value; then go to the sub step 1056. Step 1056, the new PWM control signal is output to the drive 3, maintain the light intensity of the user reading area in the setting level; then go to the sub step 1057.

Sub step 1057, end the sub step, and then go back to the main control flow chart.

### 2. The Second Embodiment

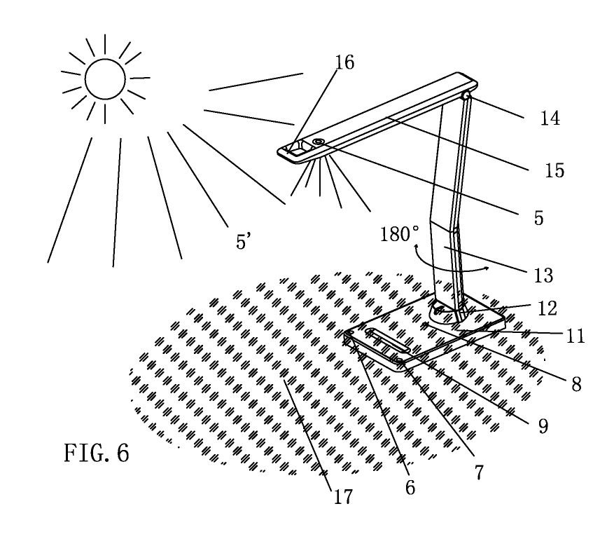

Refer to the FIG. 6, the usage status of the table lamp of light auto adjustable in the present invention. The mechanism of the light auto adjust table lamp includes a base 11, a rotating seat 12, a stand pole 13, a damping axis 14 and a pendulum 15. The rotating seat 12 is disposed on the top surface of the rear of the base 11. The rotating seat 12 rotates about the base 11 left (−) or right (+) in 90°. The lower end of the stand pole 13 is fixed to the rotating seat 12. The upper end of the stand pole 13 joints to the pendulum 15 of swinging horizontally by the damping axis 14. The front of the pendulum 15 is disposed with handle 16, and the rear of the handle 16 is disposed with LED 5 (lighting equipment). An optical sensor A 6 is disposed in the left on the top surface of the front edge of the base 11, while an optical sensor B 7 is disposed in the right; an optical sensor C 8 is disposed in the middle of the top surface of the base 11. A keyboard 9 is disposed in the middle on the top surface of the base 11. The user reading area 17 is formed under the glare of the environment light 5′ and the LED light 5.

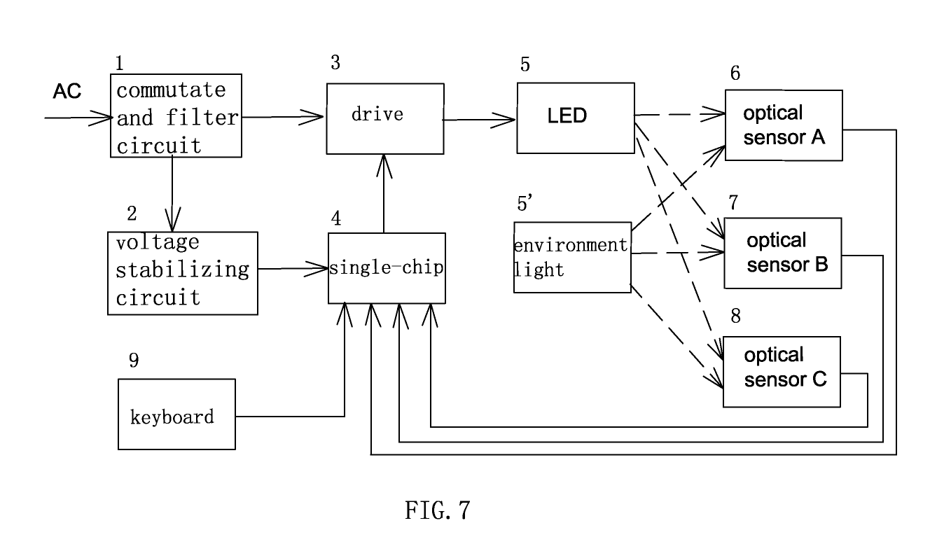

Refer to the FIG. 7, the electronic structure of the table lamp of light auto adjustable includes a commutate and filter circuit 1, a voltage stabilizing circuit 2, a drive 3, a single-chip 4, the LED 5, the optical sensor A 6, the optical sensor B 7, the optical sensor C 8 and the keyboard 9.

The commutate and filter circuit 1 transforms the AC mains to low-voltage DC provided to the voltage stabilizing circuit 2 and the drive 3 separately. The voltage stabilizing circuit 2 supplies with the working voltage for the single-chip 4. The drive 3 receives the PWM signal from the single-chip 4 and supplies energy to the LED 5. The four input ports of the single-chip joints to the keyboard 9, the optical sensor A 6 and the optical sensor B 7 and the optical sensor C 8 separately. The single-chip 4 controls the drive 3 to supply energy to the LED 5 according to the comparison of the real time light intensity of the user reading area 17 and the light intensity setting value from the keyboard 9, maintaining the light intensity of the user reading area 17 in the setting level. The optical sensor A 6 and the optical sensor B 7 are photoresistors. The single-chip 4 takes AD sample for the voltage of these photoresistors.

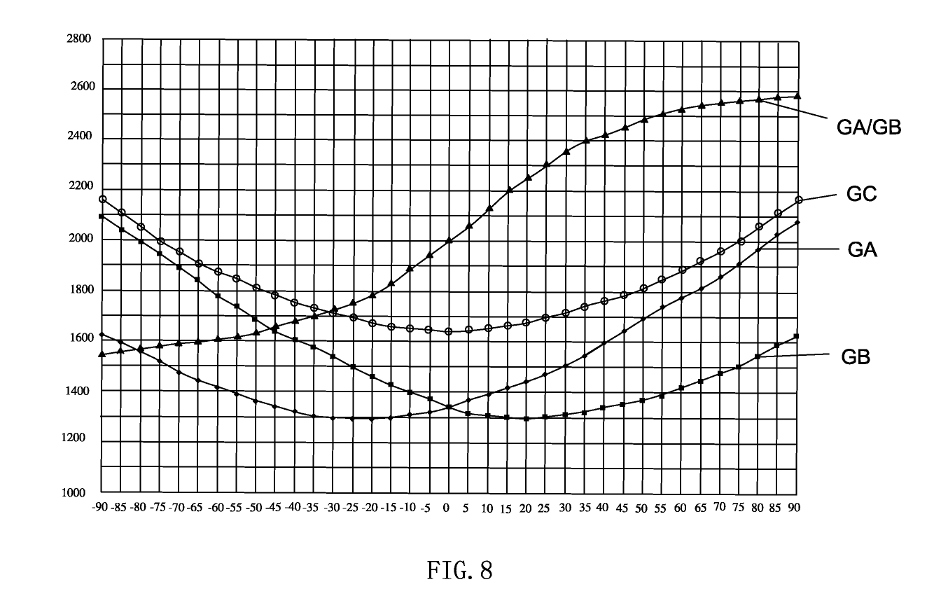

The light adjust method for the light adjustable table lamp measures the light intensity data of the optical sensor A 6, the optical sensor B 7 and the optical sensor C 8 when the pendulum 15 is at different deflection angle; make the ratio-angle sheet AB about the ratio of the light intensity data of the optical sensor A 6 to the optical sensor B 7 and the pendulum 15 deflection angle, refer to the FIG. 8 of the ratio-angle sheet AB; make the ratio-angel sheet AC about the ratio of the light intensity data of the optical sensor A 6 to the optical sensor C 8 and the pendulum deflection angle; make the ratio-angel sheet BC about the ratio of the light intensity data of the optical sensor B 7 to the optical sensor C 8 and the pendulum deflection angle; make the angle-light intensity sheet AB about the relative relationship between the light intensity data of the optical sensor A 6 and the optical sensor B 7 when the pendulum 15 is at different deflection angle and the light intensity of the user reading area 17; make the sub sheet about the every deflection angle of the pendulum 15 in the angle-light intensity sheet AB, and every sub sheet records the light intensity of the user reading area 17 corresponding to the different light intensity data of the optical sensor A 6 and the optical sensor B 7 in this pendulum deflection angle; make the angle-light intensity sheet AC about the relative relationship between the light intensity data of the optical sensor A 6 and the optical sensor C 8 when the pendulum 15 is at different deflection angle and the light intensity of the user reading area 17; make the sub sheet about the every deflection angle of the pendulum 15 in the angle-light intensity sheet AC, and every sub sheet records the light intensity of the user reading area 17 corresponding to the different light intensity data of the optical sensor A 6 and the optical sensor C 8 at this pendulum deflection angle; make the angle-light intensity sheet BC about the relative relationship between the light intensity data of the optical sensor B 7 and the optical sensor C 8 when the pendulum 15 is at different deflection angle and the light intensity of the user reading area 17; make the sub sheet about the every deflection angle of the pendulum 15 in the angle-light intensity sheet BC, and every sub sheet records the light intensity of the user reading area corresponding to the different light intensity data of the optical sensor B 7 and the optical sensor C 8 at this pendulum deflection angle.

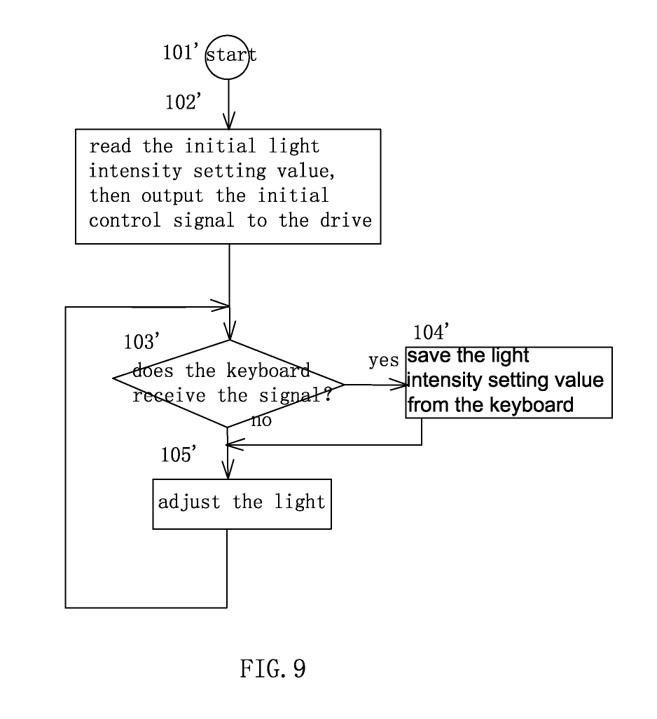

Refer to the FIG. 9 about the main control flow chart of this embodiment.

Step 101′, the main control flow chart is started when the single-chip 4 is powered; then go to the step 102′.

Step 102′, the single-chip 4 read the first light intensity setting value S from the internal memory and output the initial PWM signal to the drive 3, then go to the step 103′.

Step 103′, check that whether the keyboard 9 receives input signal, if does, then go to the step 104; if does not, then go to the step 105′.

Step 104′, read and save the light intensity setting value S of the user reading area 17 from the keyboard 9, then go to the step 105′.

Step 105′, adjust the light, and then go to the step 103′.

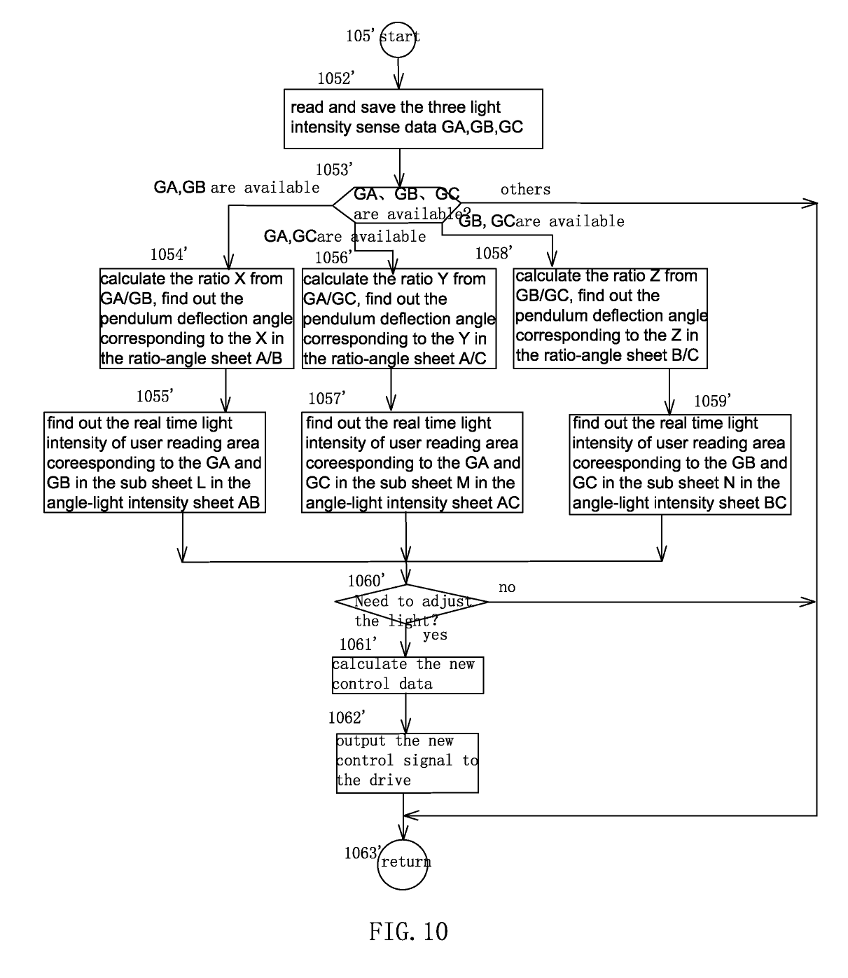

Refer to the FIG. 10 about the light adjust function subprogram in the step 105′.

Sub step 1052′, read and save the light intensity sense data GA, GB and GC of the optical sensor A 6, the optical sensor B 7 and the optical sensor C; read several times (such as 12 times) of the light intensity data of the optical sensor A 6 when reading the light intensity sense data GA, GB and GC of the optical sensor A 6, the optical sensor B 7 and the optical sensor C 8, and take the average value as the light intensity data GA, the same as the light intensity data GB and GC. Then start the digital filtering and go to the sub step 1053′.

Sub step 1053′, judge that whether the three light intensity data GA, GB and GC is available, whether the value is bigger than the setting value; if the light intensity data GA and GB is available, the optical sensor A 6 and the optical sensor B 7 are not shielded, then go to the sub step 1054′; if the light intensity data GA and GC is available, the optical sensor B 7 is shielded, then go to the sub step 1056′; if the light intensity data GB and GC is available, the optical sensor A 6 is shielded, then go to the sub step 1058′; if only one of the light intensity data GA, GB and GC is available, two of the optical sensors are shielded, the light adjust is invalid, then go to the sub step 1063′.

Sub step 1054′, calculate the ratio X (GA/GB) of the two light intensity sense data GA and GB, find out the pendulum deflection angle L corresponding to the ratio X in the ratio-angle sheet; then go to the sub step 1055′.

Sub step 1055′, find out the real time light intensity Q of the user reading area corresponding to the two light intensity sense data GA and GB in the angle-light intensity sheet, then go to the sub step 1060′.

Sub step 1056′, calculate the ratio Y (GA/GC) of the two light intensity sense data GA and GC, find out the pendulum deflection angle M corresponding to the ratio Y in the ratio-angle sheet; then go to the sub step 1055′.

Sub step 1057′, find out the real time light intensity Q of the user reading area corresponding to the two light intensity sense data GA and GC in the pendulum deflection angle M of the angle-light intensity sheet, then go to the sub step 1060′.

Sub step 1058′, calculate the ratio Z (GB/GC) of the two light intensity sense data GB and GC, find out the pendulum deflection angle N corresponding to the ratio Z in the ratio-angle sheet; then go to the sub step 1055′.

Sub step 53′, find out the real time light intensity Q of the user reading area corresponding to the two light intensity sense data GB and GC in the pendulum deflection angle N of the angle-light intensity sheet, then go to the sub step 1060′.

Sub step 1060′, make a judgment about whether the light intensity Q is equal to the light intensity setting value S, if equal, it's no need to adjust the light, then go to the sub step 1063′; if unequal, adjust the light, then go to the sub step 1061′.

Sub step 1061′, calculate the new control data from the real time light intensity Q and the light intensity setting value S. firstly calculate the feedback compensation value in the equation W=S−aQ, where the a is the proportionality. Correct the PWM signal pulse-width (the duty ratio) according to the feedback compensation value W; then go to the sub step 1062′.

Sub step 1062′, the new PWM control signal is output to the drive 3, maintain the light intensity of the user reading area in the setting level; then go to the sub step 1063′.

Sub step 1063′, end the sub step, and then go back to the main control flow chart.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. A light adjust table lamp includes a base, a stand pole, a lighting equipment, optical sensor, adjust device and a controller; the adjust device provides state parameter to the controller; wherein the adjust device is a keyboard, the state parameter is the light intensity setting value of the user reading area; the controller includes single-chip and a drive; the lower end of the stand pole is disposed in the rear of the base, the upper end of the stand pole is disposed with a pendulum which can swing horizontally, the lighting equipment is disposed in the front of the pendulum; an optical sensor A and an optical sensor B are disposed on the top surface in the front of the base; the three input ports of the single-chip joints to the keyboard, the optical sensor A and the optical sensor B separately; the single-chip calculates automatically the real time light intensity of the user reading area according to the light intensity signals of the optical sensor A and the optical sensor B, then the single-chip controls the drive with the energy supplied to the lighting equipment according to the light intensity setting value of the user reading area by the keyboard, maintaining the light intensity of the user reading area in the given level.

2. Light auto adjust method for a light adjustable table lamp according to the claim 1, wherein the light adjustable table lamp includes a base, a stand pole, a lighting equipment, optical sensor, a keyboard, a single-chip and a drive; the lower end of the stand pole is disposed in the rear of the base, the upper end of the stand pole is disposed with a pendulum which can swing horizontally, the lighting equipment is disposed in the front of the pendulum; an optical sensor A and an optical sensor B are disposed on the top surface in the front of the base; the three input ports of the single-chip joints to the keyboard, the optical sensor A and the optical sensor B separately; the single-chip controls the drive to transport the energy to the lighting equipment; the steps of the light adjustable table lamp to adjust light are:
Step 1, measure the light intensity data of the optical sensor A and the optical sensor B when the pendulum is at the different deflection angle; make the ratio-angle sheet about the relative relationship of the ratio of the light intensity data of the optical sensor A to the optical sensor B and the deflection angel of the pendulum; make the angle-light intensity sheet about the relative relationship of the light intensity data of the optical sensor A and the optical sensor B when the pendulum is at different deflection angle and the light intensity of the user reading area; make sub sheet for every deflection angle of the pendulum in the angle-light intensity sheet; every sub sheet records the light intensity value of the user reading area for the different light intensity data of the optical sensor A and the optical sensor B at the corresponding deflection angle of the pendulum, then go to the step 2;
Step 2, if the keyboard receives signal, read and save the light intensity setting value of the user reading area provided by the keyboard; then go to the step 3;
Step 3, read and save the light intensity sense data GA, GB of the optical sensor A and the optical sensor B, then go to the step 4;
Step 4, calculate the ratio X of the two light intensity sense data GA and GB, find out the pendulum deflection angle L corresponding to the ratio X in the ratio-angle sheet;
Step 5, find out the real time light intensity Q of the user reading area corresponding to the two light intensity sense data GA and GB in the angle-light intensity sheet, then go to the step 6;
Step 6, make a judgment about whether the light intensity Q is equal to the light intensity setting value S, if equal, it's no need to adjust the light, then go to the step 2; if unequal, adjust the light, then go to the step 7;
Step 7, calculate the new control data from the real time light intensity Q and the light intensity setting value S, then go to the step 8;
Step 8, the new control signal is output to the drive, maintain the light intensity of the user reading area in the setting value, then go the step 2.

3. A light adjustable table lamp includes a base, a stand pole, a lighting equipment, optical sensor, an adjust device and a controller; the adjust device provides the state parameter to the controller; wherein the adjust device is a keyboard, and the state parameter is the light intensity setting value of the user reading area; the controller includes a single-chip and a drive; the lower end of the stand pole is disposed in the rear of the base, the upper end of the stand pole is disposed with a pendulum which can swing horizontally; the lighting equipment is disposed in the front of the pendulum; an optical sensor A, an optical sensor B and an optical sensor C are disposed on the top surface of the front of the base; the four input ports of the single-chip joints to the keyboard, the optical sensor A, the optical sensor B and the optical sensor C separately; the single-chip calculates the real time light intensity of the user reading area automatically according to any two of the optical sensors of the optical sensor A, the optical sensor B and the optical sensor C; then the single-chip controls the drive to supply energy to the lighting equipment according to the light intensity setting value of the user reading area by the keyboard, maintaining the light intensity of the user reading area in the given level.

4. Light auto adjust method for a light adjustable table lamp according to the claim 3, the light adjustable table lamp includes a base, a stand pole, a lighting equipment, optical sensor, a keyboard, a single-chip and a drive; the lower end of the stand pole is disposed in the rear of the base, the upper end of the stand pole is disposed with a pendulum which can swing horizontally; the lighting equipment is disposed in the front of the pendulum; an optical sensor A, an optical sensor B and an optical sensor C are disposed on the top surface of the front of the base; the four input ports of the single-chip joints to the keyboard, the optical sensor A, the optical sensor B and the optical sensor C separately; the single-chip controls the drive to supply energy to the lighting equipment; the steps of the light adjustable table lamp to adjust light are:
Step 1′, measure the light intensity data of the optical sensor A, the optical sensor B and the optical sensor C when the pendulum is at different deflection angle; make the ratio-angle sheet AB about the ratio of the light intensity data of the optical sensor A to the optical sensor B and the pendulum deflection angle; make the ratio-angel sheet AC about the ratio of the light intensity data of the optical sensor A to the optical sensor C and the pendulum deflection angle; make the ratio-angel sheet BC about the ratio of the light intensity data of the optical sensor B to the optical sensor C and the pendulum deflection angle; make the angle-light intensity sheet AB about the relative relationship between the light intensity data of the optical sensor A and the optical sensor B when the pendulum is at different deflection angle and the light intensity of the user reading area; make the sub sheet about the every deflection angle of the pendulum in the angle-light intensity sheet AB, and every sub sheet records the light intensity of the user reading area corresponding to the different light intensity data of the optical sensor A and the optical sensor B in this pendulum deflection angle; make the angle-light intensity sheet AC about the relative relationship between the light intensity data of the optical sensor A and the optical sensor C when the pendulum is at different deflection angle and the light intensity of the user reading area; make the sub sheet about the every deflection angle of the pendulum in the angle-light intensity sheet AC, and every sub sheet records the light intensity of the user reading area corresponding to the different light intensity data of the optical sensor A and the optical sensor C in this pendulum deflection angle; make the angle-light intensity sheet BC about the relative relationship between the light intensity data of the optical sensor B and the optical sensor C when the pendulum is at different deflection angle and the light intensity of the user reading area; make the sub sheet about the every deflection angle of the pendulum in the angle-light intensity sheet BC, and every sub sheet records the light intensity of the user reading area corresponding to the different light intensity data of the optical sensor B and the optical sensor C in this pendulum deflection angle; then go to the step 2′;
Step 2′, if the keyboard receives signal, read and save the light intensity setting value S of the user reading area from the keyboard, then go to the step 3′;
Step 3′, read and save the light intensity sense data GA, GB and GC from the optical sensor A, optical sensor B and the optical C; then go to the step 31′;
Step 31′, judge that whether the light intensity sense data GA, GB and GC from the optical sensor A, optical sensor B and the optical C are available data; if the light intensity sense data GA and GB from the optical sensor A and the optical sensor B are available, the optical sensor A and the optical sensor B are not be shielded, then go to the step 41′; if the light intensity sense data GA and GC from the optical sensor A and the optical sensor C are available, the optical sensor B is shielded, then go to the step 42′; if the light intensity sense data GB and GC are available, the optical sensor A is shielded, then go to the step 43′; if only one of the three light intensity sense data GA, GB and GC is available, there are two optical sensors are shielded and the table lamp is disadjustable, then go to the step 2′;
Step 41′, calculate the ratio X of the two light intensity sense data GA and GB, and find out the pendulum deflection angle L corresponding to the ratio X in the ratio-angle sheet AB; then go to the step 51′;
Step 51′, Find out the real time light intensity value Q of the user reading area corresponding to the two light intensity sense data GA and GB in the angle-light intensity sheet AB; then go to the step 6′;
Step 42′, calculate the ratio Y of the two light intensity sense data GA and GC, and find out the pendulum deflection angle M corresponding to the ratio Y in the ratio-angel sheet AC; then go to the step 52′;
Step 52′, find out the real time light intensity value Q of the user reading area corresponding to the two light intensity sense data GA and GC in the angle M sub sheet of the angle-light intensity AC; then go to the step 6′;
Step 43′, calculate the ratio Z of the two light intensity sense data GB and GC, find out the pendulum deflection angle N corresponding to the ratio Z in the ratio-angle sheet BC; then go to the step 53′;
Step 53′, find out the real time light intensity value Q of the user reading area corresponding to the two light intensity sense data GB and GC in the angle N sub sheet of the angle-light intensity BC; then go to the step 6′
Step 6′, judge whether the real time light intensity value Q is equal to the light intensity setting value S; if equal, no need to adjust the light, then go to the step 2′; if unequal, adjust the light, then go to the step 7′;
Step 7′, calculate the new control data from the real time light intensity value Q and the light intensity setting value S, then go to the step 8′;
Step 8′, the new control signal is output to the drive, maintain the light intensity of the user reading area in the setting level; then go to the step 2′.
